(19) United States
(12) Patent Application Publication
(10) Pub. No.: US 2006/0255297 A1
(43) Pub. Date: Nov. 16, 2006

(54) ELECTRON EMISSION SOURCE, METHOD OF PREPARING THE SAME, AND ELECTRON EMISSION DEVICE USING THE ELECTRON EMISSION SOURCE

(75) Inventors: Jong-Woon Moon, Suwon-si (KR); Sung-Hee Cho, Suwon-si (KR); Jae-Sang Ha, Yeongtong-gu (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd., Suwon-si (KR)

(21) Appl. No.: 11/380,676

(22) Filed: Apr. 28, 2006

(30) Foreign Application Priority Data
May 14, 2005 (KR) 10-2005-0040380

(51) Int. Cl. G21G 4/00

(52) U.S. Cl. 250/493.1; 250/515.1; 250/504 R

(57) ABSTRACT

An electron emission source including a carbon-based material and a UV shielding material, a method of preparing the same, and an electron emission device using the electron emission source are provided. The UV shielding material is added to an electron emission source forming composition to more easily control the sharpness of an electron emission source tip. The electron emission source composition may include a carbon-based material, a vehicle including a resin and a solvent, and a UV shielding material.

### CROSS-REFERENCE TO RELATED APPLICATION

This application claims priority to and the benefit of Korean Patent Application No. 10-2005-0040380, filed on May 14, 2005, which is hereby incorporated by reference for all purposes as if fully set forth herein.

### BACKGROUND OF THE INVENTION

1. Field of the Invention

The present invention relates to an electron emission source, a method of preparing the same, and an electron emission device using the electron emission source, and more particularly, to an electron emission source having a desired film sharpness, a method of preparing the same, and an electron emission device using the electron emission source.

2. Discussion of the Background

Generally, an electron emission device is a display device that emits light when a voltage is applied between an anode and a cathode to form an electric field. Electrons emitted from an electron emission source, which may be arranged on the cathode, collide with a fluorescent material, which may be arranged on a lower surface of the anode.

Carbon-based materials, including carbon nanotubes (CNTs), enable an electron emission device to be easily operated at a low voltage and an electron emission source to have a large area due to good conductivity and electric field concentration effect, low work function, and good field emission characteristics. Thus, carbon-based materials are often utilized as an electron emission source of the electron emission device.

An electron emission source including CNTs may be prepared by, for example, a CNT growth method using chemical vapor deposition (CVD) or the like, or a paste method using an electron emission source forming composition including CNT.

With the paste method, it may be cheaper to manufacture the electron emission source, which may be also be formed with a large area. For example, U.S. Pat. No. 6,436,221 discloses an electron emission source forming composition including CNT.

In a conventional process of preparing an electron emission source including a carbon-based material, such as CNT, an electron emission source forming composition is applied to an electrode and then exposed to light. Referring to FIG. 1, region A of an electron emission source 11 formed on a transparent electrode 10 is over-exposed. Thus, the area of an electron emission source layer exceeds a designed value. In FIG. 1, the arrows denote the UV irradiation direction.

To solve the above problem, a method of obtaining an electron emission source having a desired tip sharpness by controlling processing conditions, i.e., exposure, development, and other conditions, was proposed.

However, it may be difficult to obtain an electron emission source having a desired tip sharpness by controlling processing conditions.

### SUMMARY OF THE INVENTION

The present invention provides an electron emission source forming composition that may be capable of obtaining a uniform electron emission property since the distance between a gate electrode and an electron emission source is maintained in a designed value and that may prevent a short between the electron emission source and the gate electrode due to over-exposure, an electron emission source using the same, a method of preparing the electron emission source, and an electron emission device having improved reliability using the electron emission source.

Additional features of the invention will be set forth in the description which follows, and in part will be apparent from the description, or may be learned by practice of the invention.

The present invention discloses an electron emission source including a carbon-based material and a UV shielding material.

The present invention also discloses a method of preparing an electron emission source. An electron emission source forming composition including a carbon-based material, a vehicle composed of a resin and a solvent, and a UV shielding material is printed on a substrate. The printed electron emission source forming composition is then calcined.

The present invention also discloses an electron emission device including an electron emission source having a carbon-based material and a UV shielding material.

The present invention also discloses an electron emission source forming composition including a carbon-based material, a vehicle composed of a resin and a solvent, and a UV shielding material.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows a film pattern of an electron emission source formed according to a conventional method.

FIG. 2 shows a film pattern of an electron emission source formed according to an exemplary embodiment of the present invention.

FIG. 3 is a schematic cross-sectional view of an electron emission device according to an exemplary embodiment of the present invention.

FIG. 4 is an SEM image showing a film pattern of an electron emission source of Example 1 according to an exemplary embodiment of the present invention.

FIG. 5 is an SEM image showing a film pattern of an electron emission source of Comparative Example 1.

### DETAILED DESCRIPTION OF THE ILLUSTRATED EMBODIMENTS

The present invention will now be described more fully with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

An electron emission source forming composition according to an exemplary embodiment of the present invention includes a carbon-based material, a vehicle composed of a resin and a solvent, and a UV shielding material. The UV shielding material may be any material that protects against UV. Hence, the UV shielding material may block and/or absorb UV, and it is generally black. Examples of the UV shielding material include V, Cr, Mn, Cu, TiO₂, ZnO, carbon black, and an oxide of V, Cr, Mn, and Cu.

The amount of the UV shielding material may be about 0.1-50 parts by weight based on 1 part by weight of the carbon-based material. When the amount of the UV shielding material is less than about 0.1 parts by weight, the UV protecting effect may not be obtained. When the amount of the UV shielding material exceeds about 50 parts by weight, the exposure efficiency may be abruptly reduced due to excessive UV absorption, and thus a tip may not be formed.

The composition may further include about 0.25-50 parts by weight of a frit based on 1 part by weight of the carbon-based material. An example of the frit includes B₂O₃—Bi₂O₃—SnO—P₂O₅.

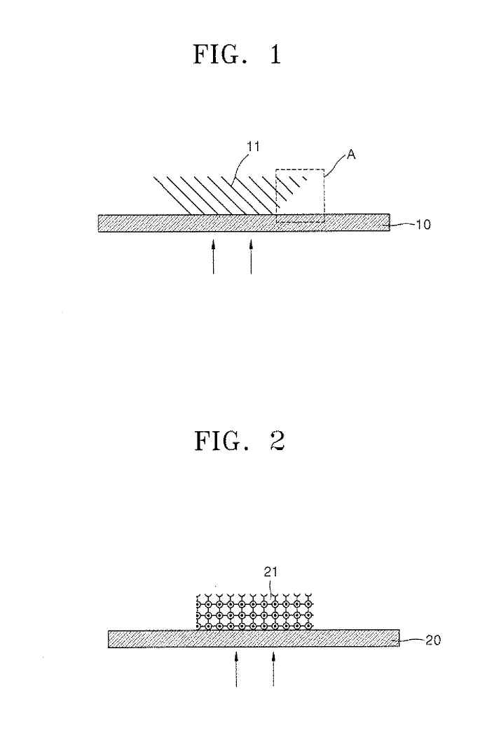

The UV shielding material may be added to the electron emission source forming composition in order to form an electron emission source tip having a sharpness close to a designed value using photolithography, i.e., in order to control the tip sharpness. Consequently, when such an electron emission source forming composition is printed on a substrate and exposed to light, an electron emission source 21 having a tip sharpness close to a designed value may be formed on a transparent electrode 20, as shown in FIG. 2. Additionally, the margin of an exposure process may increase, a short between the electron emission source and the gate electrode due to over-exposure may be prevented, and a substantially uniform electron emission property may be obtained since the distance between the gate electrode and the electron emission source tip may be maintained within a designed value.

The carbon-based material has good conductivity and electron emission property. Thus, it may emit electrons toward a phosphor layer of an anode to excite a phosphor when an electron emission device is operated. Examples of the carbon-based material include CNT, graphite, diamond, fullerene, silicon carbide, etc.

The vehicle in the electron emission source forming composition controls the composition's printability and viscosity. The vehicle includes a resin and a solvent. Examples of the resin include a cellulose-based resin such as ethyl cellulose, nitro cellulose, etc.; acrylic resin such as polyester acrylate, epoxy acrylate and urethane acrylate; vinyl-based resin such as polyvinyl acetate, polyvinyl butyral, polyvinyl ether, etc. Some of these resins may also act as a photosensitive resin.

The solvent may be at least one of terpineol, butyl carbitol (BC), butyl carbitol acetate (BCA), toluene, and texanol.

The amount of the resin may be about 1-20 parts by weight, and preferably about 2-10 parts by weight, based on 1 part by weight of the carbon-based material.

The amount of the solvent may be about 5-60 parts by weight, and preferably about 10-40 parts by weight, based on 1 part by weight of the carbon-based material. When the amount of the resin and/or the solvent are outside the above ranges, the printability and flowability of the electron emission source forming composition may decrease. In particular, when the amount of the vehicle exceeds the maximum limit of the above ranges, a drying time may be excessively extended.

The electron emission source forming composition may further include at least one of a photosensitive resin, a photoinitiator and a filler, if necessary.

The photosensitive resin is a material for patterning an electron emission source. Examples of the photosensitive resin include an acrylate-based monomer, a benzophenone-based monomer, an acetophenone-based monomer and a thioxanthone-based monomer. More specifically, epoxy acrylate, polyester acrylate, 2,4-diethyloxanthone, or 2,2-dimethoxy-2-phenylacetophenone may be used. The amount of the photosensitive resin may be about 2-20 parts by weight, and preferably about 5-15 parts by weight, based on 1 part by weight of the carbon-based material. When the amount of the photosensitive resin is less than about 2 parts by weight, the exposure sensitivity may be reduced. When the amount of the photosensitive resin exceeds about 20 parts by weight, development may not be efficiently performed.

The photoinitiator initiates cross-linking of the photosensitive resin when the photosensitive resin is exposed to light. An example of the photoinitiator includes benzophenone. The amount of the photoinitiator may be about 0.2-4 parts by weight, and preferably about 1-3 parts by weight, based on 1 part by weight of the carbon-based material. When the amount of the photoinitiator is less than about 0.2 parts by weight, efficient cross-linking may not be achieved, and thus the formation of a pattern may be difficult. When the amount of the photoinitiator exceeds about 4 parts by weight, the manufacturing costs may increase.

The filler may improve the conductivity of nano-sized inorganic material, which may not be sufficiently deposited onto the substrate. Examples of the filler include Ag, Al, etc.

A method of preparing an electron emission source using the electron emission source forming composition will be described below.

First, an electron emission source forming composition may be prepared using the components and amounts as described above.

Next, the prepared electron emission source forming composition may be printed on a substrate. The substrate on which an electron emission source will be arranged may vary depending on an electron emission device to be formed and may be easily selected by those skilled in the art. For example, the substrate may be a cathode when manufacturing an electron emission device in which a gate electrode is arranged between a cathode and an anode, or it may be an insulating layer that insulates a cathode and a gate electrode when manufacturing an electron emission device in which a gate electrode is arranged below a cathode.

A process of printing the electron emission source forming composition may vary depending on whether the electron emission source forming composition includes a photosensitive resin. When the composition includes a photosensitive resin, a separate photoresist pattern is not required. That is, the electron emission source forming composition including a photoresist resin may be applied to a substrate, and the electron emission source forming regions may then be exposed and developed.

On the other hand, when the electron emission source forming composition does not include a photosensitive resin, a photolithography process using a separate photoresist pattern is required. That is, a photoresist pattern is formed using a photoresist film, and then the electron emission source forming composition is provided using the photoresist pattern.

The printed electron emission source forming composition may be calcined under a substantially oxygen-free inert gas atmosphere. This calcining process may improve the adhesion between the carbon-based material and the substrate, may volatize and substantially remove the vehicle, and may melt and solidify an inorganic binder, etc., which may contribute to improved durability of an electron emission source.

The calcining temperature should be determined considering volatilization temperature and time of the vehicle. The calcining temperature may be about 350-500° C., and preferably about 450° C. When the calcining temperature is less than about 350° C., volatilization may not be sufficiently achieved. When the calcining temperature exceeds about 500° C., the manufacturing costs may increase and the substrate may be damaged.

The calcined resultant may be subjected to an activation process, if necessary. In an embodiment of the activation process, a solution, which may be hardened in a film form through heat treatment, for example, an electron emission source surface treatment agent including a polyimide-based polymer, may be applied to the calcined composition, and then is heat-treated to form a film, which is peeled. In another embodiment of the activation process, an adhesion portion may be formed on the surface of a roller, which is operated by a certain operating source, and the roller is pressed on the surface of the calcined composition with a certain pressure. Through the activation process, the nano-sized inorganic material may be controlled so as to be exposed toward the surface of the electron emission source or substantially perpendicularly oriented on the same.

The obtained electron emission source includes a carbon-based material and a UV shielding material. If necessary, a frit may be further included. The amount of the frit may be about 0.25-10 parts by weight based on 1 part by weight of the carbon-based material. When the amount of the frit is less than about 0.25 part by weight, the adhesion of the electron emission source may decrease. When the amount of the frit exceeds about 10 parts by weight, the electron emission property may decrease.

The electron emission source of the present invention may have a current density of about 100-2,000 μA/cm², and preferably about 500-1,500 μA/cm² at 5 V/μm. The electron emission source having such a current density may be suitable for an electron emission device, which may be used as a display device or a backlight unit.

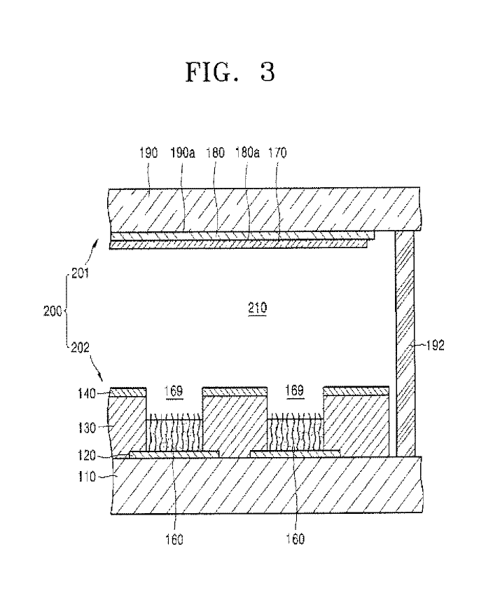

An exemplary embodiment of the electron emission device including the electron emission source of the present invention will be described below with reference to FIG. 3.

FIG. 3 is a schematic diagram of a triode electron emission device according to an exemplary embodiment of the present invention. Referring to FIG. 3, an electron emission device 200 includes an upper plate 201 and a lower plate 202. The upper plate 201 includes an upper substrate 190, an anode 180 arranged on a lower surface 190a of the upper substrate 190, and a phosphor layer 170 arranged on a lower surface 180a of the anode 180.

The lower plate 202 includes a lower substrate 110 arranged at a predetermined distance facing the upper substrate 190, a cathode 120 arranged on the lower substrate 110 in a stripe form, a gate electrode 140 arranged in a stripe form so as to cross the cathode 120, an insulating layer 130 arranged between the gate electrode 140 and the cathode 120, an electron emission source hole 169 arranged in a part of the gate electrode 140, and an electron emission source 160. The electron emission source 160 is arranged in the electron emission source hole 169, electrically coupled with the cathode 120, and has a height lower than the gate electrode 140. A detailed description of the electron emission source 160 is as described above.

The upper plate 201 and the lower plate 202 are kept in a vacuum at a pressure below atmospheric pressure, and a spacer 192 is arranged between the upper plate 201 and the lower plate 202 so as to support the upper plate 201 and the lower plate 202 and divide an emission space 210.

The anode 180 applies a voltage required to accelerate electrons emitted from the electron emission source 160 so as to allow the electrons to collide with the phosphor layer 170 at high speed. Thus, the phosphor layer 170 is excited and the energy level thereof drops to a low level, thereby emitting visible rays.

The gate electrode 140 allows electrons to be easily emitted from the electron emission source 160, and the insulating layer 130 divides the electron emission source hole 169 and insulates the electron emission source 160 from the the gate electrode 140.

The triode electron emission device shown in FIG. 3 is only an example, and exemplary embodiments of the present invention may also include a diode and other electron emission devices. Additionally, the present invention includes an electron emission device having a gate electrode placed below a cathode, as well as an electron emission device having a grid/mesh that prevents a gate electrode and/or a cathode to be damaged by arc, which is assumed to be generated due to electric discharge, and assures focusing of electrons emitted from an electron emission source. The structure of the electron emission device may be applied to a display device.

Exemplary embodiments of the present invention will be described in greater detail below with reference to the following examples, which are for illustrative purposes only and are not intended to limit the scope of the invention.

### PREPARATION EXAMPLE 1

1 g of CNT powder (multi walled nanotube (MWNT), ILJIN Nanotech Co. Ltd), 5 g of carbon black as a UV shielding material, 10 g of polyester acrylate, 5 g of benzophenone, 4 g of ethylcellulose, 10 g of a frit, and 25 g of a metal filler were added to 40 g of terpineol, and then the mixture was stirred to prepare an electron emission source forming composition.

PREPARATION EXAMPLE 2

An electron emission source forming composition was prepared in the same manner as in Preparation Example 1, except that 5 g of TiO₂ was used as a UV shielding material instead of 5 g of carbon black.

PREPARATION EXAMPLE 3

An electron emission source forming composition was prepared in the same manner as in Preparation Example 1, except that 5 g of Cr₂O₃ was used as a UV shielding material instead of 5 g of carbon black.

COMPARATIVE PREPARATION EXAMPLE 1

1 g of CNT powder (MWNT, Iljin nanotech), 5 g of polyester acrylate, and 5 g of benzophenone were added to 10 g of terpineol, and then the mixture was stirred to prepare an electron emission source forming composition.

EXAMPLE B 1

The electron emission source forming composition obtained in Preparation Example 1 was printed on a substrate having a Cr gate electrode, an insulating layer and an ITO electrode, and then exposure energy of 2,000 mJ/cm² was irradiated thereto using a pattern mask and a parallel exposure system. The exposed resultant was then developed with acetone and calcined at 450° C. in the presence of nitrogen gas to form an electron emission source.

Thereafter, a substrate having a phosphor layer and an ITO layer as an anode was placed so as to face the substrate having the electron emission source formed thereon, and a spacer was arranged between both substrates to maintain a gap between the substrates, thereby completing an electron emission device.

EXAMPLES 2 AND 3

Electron emission devices were manufactured in the same manner as in Example 1, except that electron emission source forming compositions obtained in Preparation Examples 2 and 3 were used instead of the electron emission source forming composition obtained in Preparation Example 1.

COMPARATIVE EXAMPLE 1

An electron emission device was manufactured in the same manner as in Example 1, except that an electron emission source forming composition obtained in Comparative Preparation Example 1 was used instead of the electron emission source forming composition obtained in Preparation Example 1.

The current density of the electron emission devices manufactured in Examples 1, 2 and 3 and Comparative Example 1 was measured using a pulse power source and an ammeter.

Comparing the results, the electron emission devices of Examples 1, 2 and 3 had an increased current density, and thus an improved electron emission property, as compared to the electron emission device of Comparative Example 1.

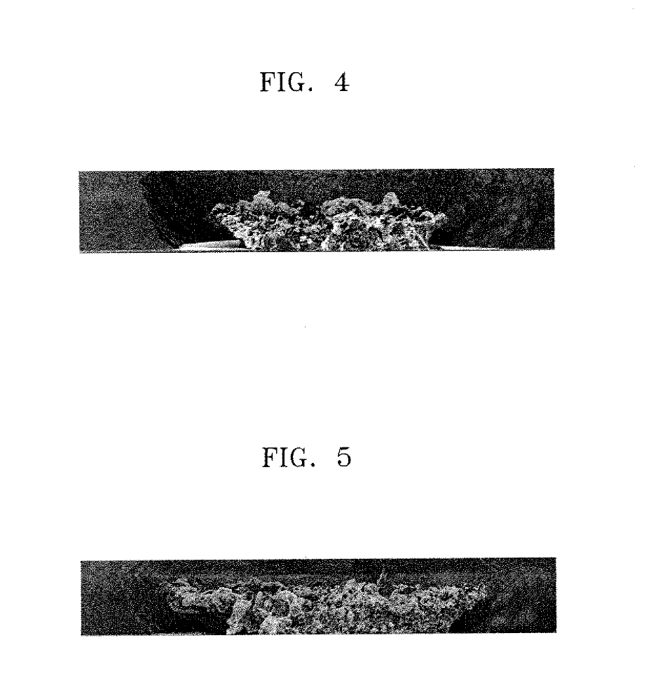

The film pattern of the electron emission source prepared in Example 1 and Comparative Example 1 was investigated using a scanning electron microscope (SEM), and FIG. 4 and FIG. 5 show the results.

FIG. 4 is an SEM image of the film pattern of the electron emission source of Example 1, and FIG. 5 is an SEM image of the film pattern of the electron emission source of Comparative Example 1. Referring to FIG. 4 and FIG. 5, it may be seen that the electron emission source of Example 1 has a film pattern with an improved sharpness as compared to the electron emission source of Comparative Example 1.

Although not shown in FIG. 4, the electron emission sources of Examples 2 and 3 had a film pattern with an improved sharpness as compared to the electron emission source of Comparative Example 1.

The electron emission source forming composition according to exemplary embodiments of the present invention contains a UV shielding material. Thus, the sharpness of an electron emission source tip may be more easily controlled. When using the electron emission source forming composition, the margin of a process of forming an electron emission source may increase, the electron emission source produced from the composition may have a substantially uniform electron emission property since the distance between the gate electrode and the electron emission source is maintained within a designed value, and a short between the electron emission source and the gate electrode due to over-exposure may be prevented.

When using the electron emission source of the present invention, an electron emission device may have improved reliability.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electron emission source, comprising:
a carbon-based material; and
a UV shielding material.

2. The electron emission source of claim 1, wherein an amount of the UV shielding material is about 0.1 to 50 parts by weight based on 1 part by weight of the carbon-based material.

3. The electron emission source of claim 1, wherein the UV shielding material is at least one material selected from the group consisting of V, Cr, Mn, Cu, an oxide of V, an oxide of Cr, an oxide of Mn, an oxide of Cu, TiO₂, ZnO, and carbon black.

4. The electron emission source of claim 1, wherein the carbon-based material comprises at least one of carbon nanotubes, graphite, diamond, fullerene, and silicon carbide.

5. The electron emission source of claim 1, further comprising:
a frit,
wherein an amount of the frit is about 0.25 to 10 parts by weight based on 1 part by weight of the carbon-based material.

6. An electron emission device comprising the electron emission source of claim 1.

7. The electron emission device of claim 6, further comprising:
a first substrate;
a second substrate facing the first substrate;
a cathode arranged on the first substrate;
an anode arranged on the second substrate; and
a phosphor layer emitting light due to electrons that are emitted from the electron emission source,
wherein the electron emission source is electrically coupled with the cathode.

8. A method of preparing an electron emission source, comprising:
printing an electron emission source forming composition on a substrate; and
calcining the printed electron emission source forming composition,
wherein the electron emission source forming composition comprises a carbon-based material, a vehicle comprising a resin and a solvent, and a UV shielding material.

9. The method of claim 8, further comprising:
exposing and developing an electron emission source forming region,
wherein the electron emission source forming composition further comprises at least one material selected from the group consisting of a frit, a photosensitive resin, a photoinitiator, and a filler.

10. The method of claim 8, wherein the calcining is carried out at a temperature of about 350° C. to 500° C.

11. The method of claim 10, wherein the calcining is carried out at a temperature of about 450° C.

12. An electron emission source forming composition, comprising:
a carbon-based material;
a vehicle comprising a resin and a solvent; and
a UV shielding material.

13. The electron emission source forming composition of claim 12, wherein an amount of the UV shielding material is about 0.1 to 50 parts by weight based on 1 part by weight of the carbon-based material.

14. The electron emission source forming composition of claim 12, wherein the UV shielding material is at least one material selected from the group consisting of V, Cr, Mn, Cu, an oxide of V, an oxide of Cr, an oxide of Mn, an oxide of Cu, TiO₂, ZnO, and carbon black.

15. The electron emission source forming composition of claim 12, wherein the carbon-based material comprises at least one of carbon nanotubes, graphite, diamond, fullerene, and silicon carbide.

16. The electron emission source forming composition of claim 15, wherein the carbon-based material comprises carbon nanotubes.

17. The electron emission source forming composition of claim 12, further comprising:
a frit,
wherein an amount of the frit is about 0.25 to 50 parts by weight based on 1 part by weight of the carbon-based material.

18. The electron emission source forming composition of claim 12, further comprising at least one material selected from the group consisting of a frit, a photosensitive resin, a photoinitiator, and a filler.

19. The electron emission source forming composition of claim 12, wherein an amount of the resin is about 1 to 20 parts by weight based on 1 part by weight of the carbon-based material, and an amount of the solvent is about 5 to 60 parts by weight based on 1 part by weight of the carbon-based material.

20. The electron emission source forming composition of claim 19, wherein the amount of the resin is about 2 to 10 parts by weight based on 1 part by weight of the carbon-based material, and the amount of the solvent is about 10 to 40 parts by weight based on 1 part by weight of the carbon-based material.
